(19) United States
(12) Patent Application Publication
(10) Pub. No.: US 2011/0093256 A1
(43) Pub. Date: Apr. 21, 2011

(54) Method of disambiguating information

(76) Inventor: Frank John Williams, Los Alamitos, CA (US)

(21) Appl. No.: 12/587,932

(22) Filed: Oct. 15, 2009

(51) Int. Cl. G06F 17/27

(52) U.S. Cl. 704/9

(57) ABSTRACT

A preferred method and system for disambiguating information are disclosed. In a preferred method, the word elements of homonyms form a plurality of information corpuses which are analyzed by conceptual and/or grammatical relational analysis such as CIRN for identifying successful outcomes and unsuccessful outcomes; wherein said successful outcome involve the proper grammatical classification of the homonym thus leading to identify the correct meaning.

### RELATED APPLICATIONS

This application claims the benefit of: U.S. provisional patent application Ser. No. 61/196,158, filed 2008 Oct. 14 by the present inventor.

### BACKGROUND

1. Field of Invention

The present invention relates generally to a method for identifying information. More particularly, a novel method for disambiguating a homonym through the implementations of conceptual and/or grammatical relational analysis such as CIRN.

2. Description of Related Art

The Revolution of the computer and the Internet are responsible for a series of innovations, scientific disciplines and applications, such as the Internet, computational linguistics, speech recognition, word processing, search engines and many other which have inherently changed the life and dynamics of almost all human beings. However, present technologies fail to effectively identify the meaning of homonyms (words capable of identifying multiple meanings) thus allowing for plenty of irrelevance, undesired results and user confusion. For example, the word “fries” is a homonym since it can identify the oil cooked potato as well as the action of frying or cooking. Accordingly, in an search engine, a query such as “Mary eats fries” can potentially retrieve documents wherein the homonym “fries” is implemented to describe the said oil cooked potatoes and mix said documents with other documents comprising the homonym of “fries” to identify or describe the action of cooking, thus promoting irrelevance, excessive data and confusing results.

In view of the present shortcomings, the present invention distinguishes over the prior art by providing heretofore a more compelling and effective method for identifying the meaning of words capable of identifying several meanings, thus allowing information relating applications such as search engines, translation software, word processors, and others the ability to differentiate and/or identify the intended concepts while avoiding irrelevance and erroneous data while providing additional unknown, unsolved and unrecognized advantages as described in the following summary.

### SUMMARY OF THE INVENTION

The present invention teaches certain benefits in use and construction which give rise to the objectives and advantages described below. The methods and systems embodied by the present invention overcome the limitations and shortcomings encountered when dealing with homonyms. The method(s) permits to identify, select, and/or register the meaning of a homonym in context to other words in its neighboring space, thus allowing information applications such as search engines, speech recognition software, translation software and others to overcoming irrelevance, nonsensical and undesirable data.

### OBJECTS AND ADVANTAGES

A primary objective inherent in the above described methods and systems of use is to provide a system and methods for disambiguating homonyms thus allowing information application such as search engines, speech recognition software, translation software and others to identify and handle information more effectively permitting them to overcome irrelevance and entry mistakes not taught in the prior arts while providing further advantages and objectives not taught by the prior art. Accordingly, several objects and advantages of the invention are:

Another objective is to avoid the registration of irrelevant and nonsense data during searching and recording information.

Another objective is to save user time by identifying nonsensical data.

Another objective is to speed up disambiguation techniques.

A further objective is to decrease the amount of effort implemented by users discriminating for irrelevant and nonsensical data.

A further objective is to improve the capabilities of word processing software.

A further objective is to improve the quality and quantity of results.

A further objective is to permit machines and programs to handle language more efficiently.

A further objective is to improve the ability of devices and portable devices to manipulate language information.

Another further objective is to identify documents and information providers generating nonsensical or ambiguous data.

Other features and advantages of the described methods of use will become apparent from the following more detailed description, taken in conjunction with the accompanying drawings which illustrate, by way of example, the principles of the presently described apparatus and method of its use.

### BRIEF DESCRIPTION OF THE DRAWINGS

The accompanying drawings illustrate examples of at least one of the best mode embodiments of the present method and methods of use. In such drawings:

FIG. 1 illustrates an exemplary non-limiting block diagram of many significant steps of the inventive method;

FIG. 2A is an exemplary non-limiting block diagram of the inventive method exemplifying a sentence such as “Tom is a pilot;”

FIG. 2B is an exemplary non-limiting block diagram of the inventive method exemplifying a sentence such as “Tom is a pilot;”

FIG. 2C is an exemplary non-limiting block diagram of the inventive method exemplifying a sentence such as “Tom is a pilot” and another identifying language such as grammatical eeggi;

### DETAILED DESCRIPTION

The above described drawing figures illustrate the described methods and systems and use in at least one of its preferred, best mode embodiment, which are further defined in detail in the following description. Those having ordinary skill in the art may be able to make alterations and modifications from what is described herein without departing from its spirit and scope. Therefore, it must be understood that what is illustrated is set forth only for the purposes of example and that it should not be taken as a limitation in the scope of the present system and method of use.

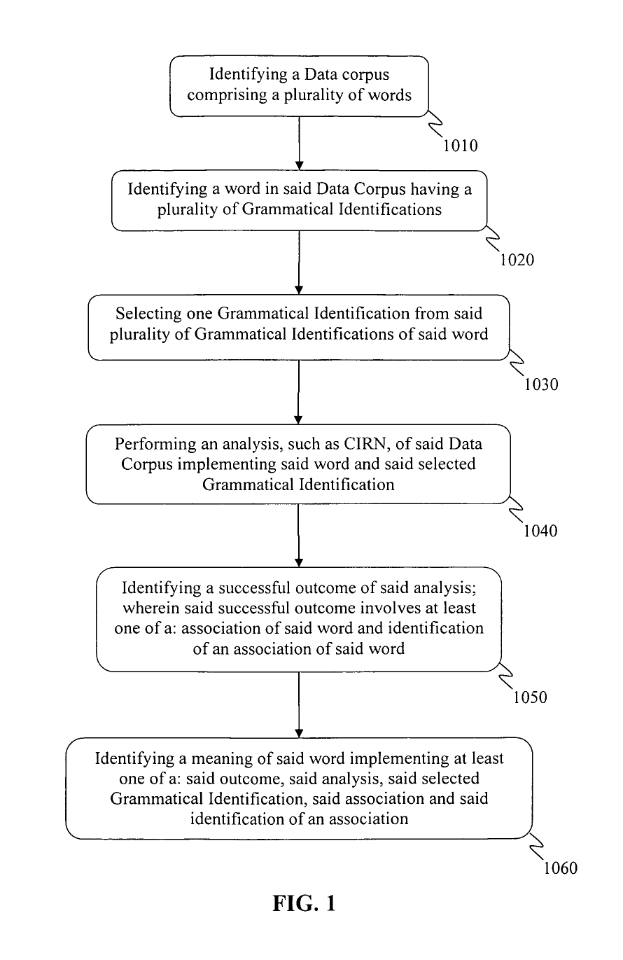

FIG. 1 illustrates an exemplary non-limiting block diagram of many significant steps of the inventive method. The First Step 1010 (FIG. 1) involves the procedure of identifying a Data Corpus comprising a plurality of words. The next step or Second Step 1020 (FIG. 1) involves the step of identifying a word in said Data Corpus having a plurality of grammatical identification. For example, in a data corpus such as the query “tom pilots the plane” a lexicon can be used to identify that the word “pilots” is has several grammatical identification such as “verb” and “noun.” This is because the word “pilots” is a homonym or a word capable of identifying several meanings such as “the action of driving or steering a vehicle” (pilots is a verb) and the “plurality of persons qualified to fly an aircraft” (pilots is a noun). The next step or Third Step 1030 (FIG. 1) involves the step of selecting one of the grammatical identifications of the said homonym. For example, from the two grammatical identifications of the word “pilots” selecting one of them, such as choosing the grammatical identification of “verb” per se. The Fourth Step 1040 (FIG. 1) involves the procedure of performing an analysis such as CIRN implementing the select grammatical identification (verb) from the previous or step (Third Step). The analysis of CIRN (or the alike) is designed to identify associations (conceptual and/or grammatical) between the words (or word elements) of a data corpus. In such fashion, when the words are arranged grammatically correct, or in lame terms “make sense,” then CIRN identifies and/or forms an association between them. In such fashion, if the word “silly” (an adjective) is next and to the left of the word “Mary” (a noun), CIRN (the analysis) finds (identifies) or forms an association (n successful outcome). Noteworthy, some CIRN analysis can simply identify or find an association, while others can actually go through the additional steps of actually forming an association in the form of database, etc. The next or Fifth Step 1050 (FIG. 1) involves the procedure of identifying a successful outcome from the said analysis (Fourth Step); wherein said successful outcome involves an association and/or the identification of an association between words. For example, from a data corpus such as “tom pilots the plane” is clear to English speakers that “pilots” is the action or verb (action of driving or steering) and not the name or noun (several persons qualified to fly a plane). Accordingly, when “tom pilots the plane” is analyzed by CIRN, it will form or identify an association if Tom (a noun) is next to a pilots (the verb—to drive or steer) yet will fails to form or identify an association if Tom (a noun) is next to pilots as a noun (a plurality of persons qualified to fly). As a result, different meanings (verb or noun) lead the CIRN analysis to generate successful or unsuccessful associations. Accordingly, this step involves identifying a successful outcome of said homonym implementing one of the grammatical identification (or meaning) it assumes. The final or Sixth Step 1060 (FIG. 1) involves the step of disambiguating the homonym, or identifying the meaning of the homonym by selecting and/or implementing at least one of a: the outcome which resulted on a association or the identification of an association, the selected grammatical identification responsible for the outcome resulting in an association or identification of an association, the analysis responsible for obtain the outcome resulting in an association or identification of an association, and finally an association or the identification of an association. For example, from the sentence “Tom pilots a plane,” two different scenarios (pilots=verb and pilots=noun) are generated. However, only one (the verb) when analyzed by CIRN (or the alike) forms an association or identifies the possibility to form an association (a successful outcome). Accordingly, any event or forms of information involved in the formation of an association or identification of said formation can effectively be used to identify that, in “Tom pilots the plane” the word “pilots” is indeed a verb or the action of driving/steering and not the noun or a group of people qualified to fly.

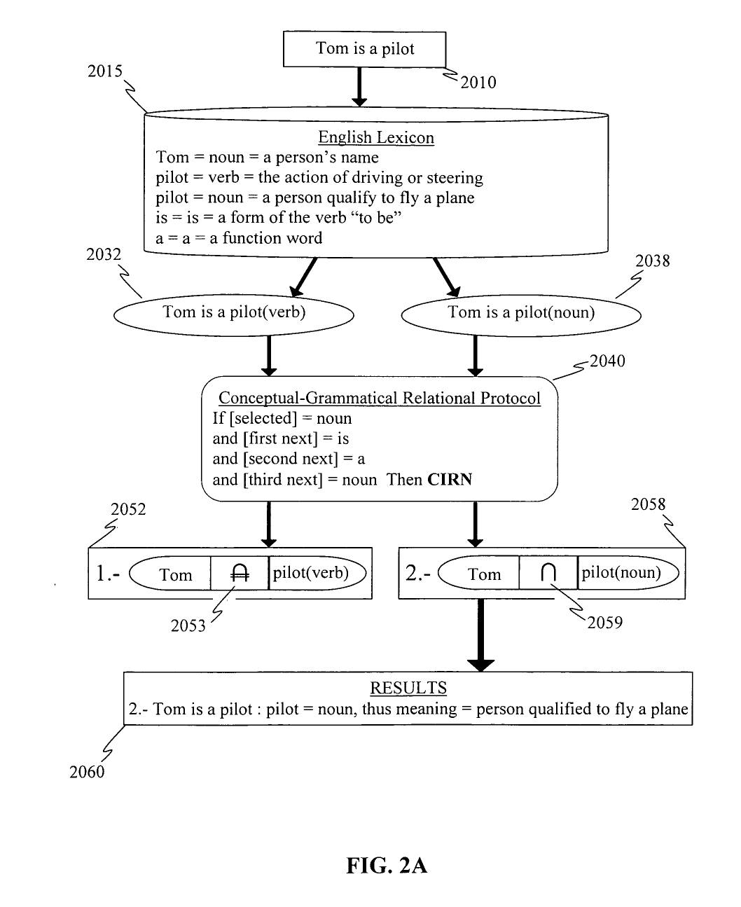

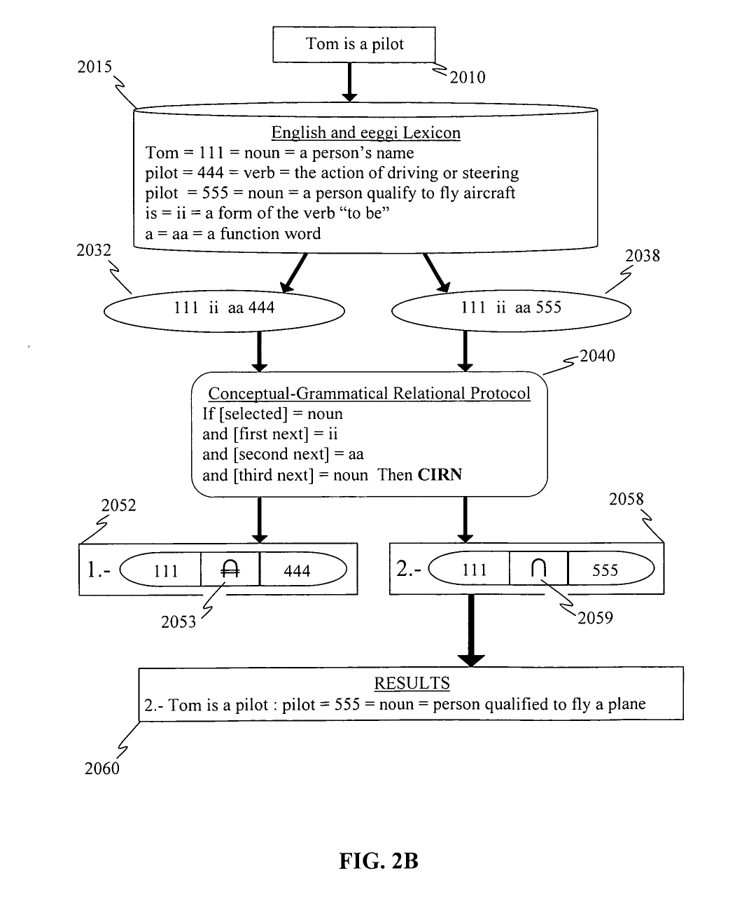

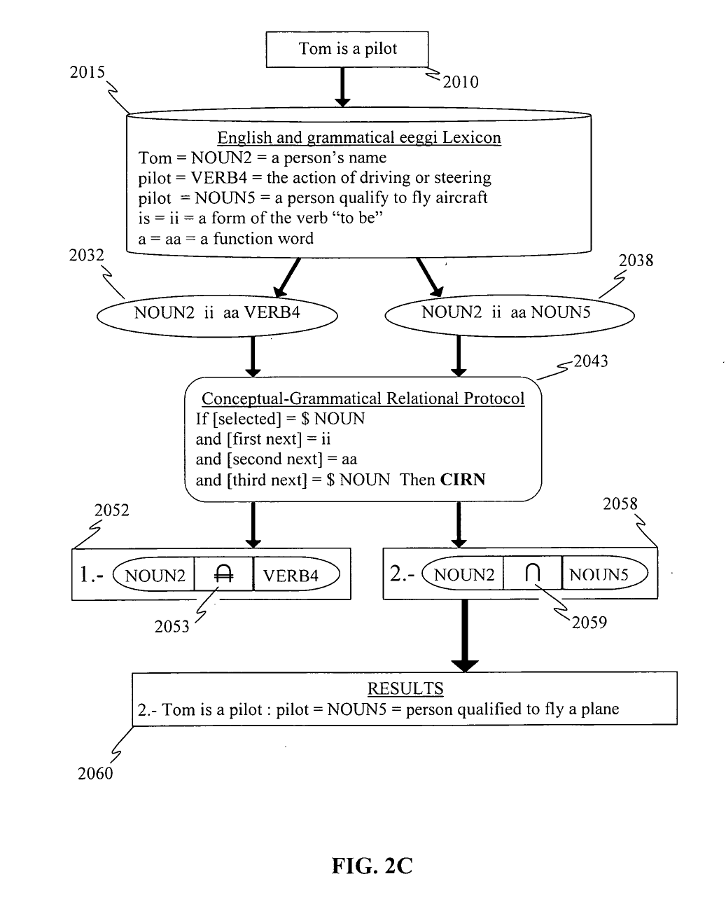

FIG. 2A is an exemplary non-limiting block diagram of the inventive method exemplifying a sentence such as “Tom is a pilot.” The Data Corpus 2010 (FIG. 2A) involves the word elements “Tom is a pilot.” Then, the Lexicon 2015 (FIG. 2A) provides information such as the grammatical identification and the meaning of every word of the Data Corpus. However, in such Lexicon it can also be appreciated that the word “pilot” comprises two meanings such as: 1) pilot=verb=the action of driving or steering, and 2) pilot=noun=a person qualify to fly a plane. Consequentially, the Data Corpus produces two different sentences each comprising a particular of different grammatical identification of the word pilot, such as the Pilot Verb Corpus 2032 (FIG. 2A) involving pilot as a verb and the Pilot Noun Corpus 2038 (FIG. 2A) involving “pilot” as a noun. Then each corpus (Pilot Verb Corpus and Pilot Noun Corpus) is compared or analyzed with a Conceptual-Grammatical Relational Protocol 2040 (FIG. 2A) such as CIRN. As depicted, the Conceptual-Grammatical Protocol makes use of a series of conditional rules to identify an association. For example, the depicted CIRN mentions that if a select word is a “noun” (If [selected=noun), and the following word (to the right as in English) happens to be “is” (and [first next]=is), and the further following word happens to be “a” (and [second next]=a), and finally the once more further word happens to be a “noun” (and [third next]=noun), then produce or identify an association (Then CIRN). Accordingly, applying said group of conditions or CIRN to each of the corpuses produces two outcomes such as the Unsuccessful Outcome 2052 (FIG. 2A) and the Successful Outcome 2058 (FIG. 2A). As illustrated, the Unsuccessful Outcome involves the word “Tom” and the word “pilot” (as a verb) on a failed association as implied by the Negative Association Symbol 2053 (FIG. 2A). On the other hand, the Successful Outcome depicts the word “Tom” and the word “pilot” (as a noun) in an association as implied by its Affirmative Association Symbol 2059 (FIG. 2A). Finally, the Results 2060 (FIG. 2) comprises the word “pilot” as a noun, the grammatical identification responsible for said association “noun,” and the meaning corresponding to said grammatical identification (a the person qualified to fly a plane).

FIG. 2B is an exemplary non-limiting block diagram of the inventive method exemplifying a sentence such as “Tom is a pilot” while implementing an identifying language such as eeggi. The Data Corpus 2010 (FIG. 2B) involves the word elements “Tom is a pilot.” Then, the Lexicon 2015 (FIG. 2B) provides a series of information such as the eeggi, the grammatical identification and the meaning of every word of the Data Corpus. However, in such a Lexicon it can also be appreciated that the word “pilot” comprises two meanings or eeggis such as: 1) pilot=444=verb=the action of driving or steering, and 2) pilot=555=noun=a person qualify to fly. Consequentially, when the Data Corpus is converted to the target language (eeggi) two different sentences are formed each comprising a particular or different eeggi of the word pilot, such as the First Eeggi Corpus 2032 (FIG. 2B) involving pilot as a verb (444) and the other or Second Eeggi Corpus 2038 (FIG. 2B) involving “pilot” as a noun (555). Then each eeggi corpus (First Eeggi Corpus and Second Eeggi Corpus) is compared or analyzed with a Conceptual-Grammatical Relational Protocol 2040 (FIG. 2B) such a CIRN. As depicted, the Conceptual-Grammatical Protocol makes use of a series of conditional rules to identify an association. For example, the depicted CIRN mentions that if a select word is a noun (If [selected=noun), and the following word (to the right as in English) happens to be ii (and [first next]=ii), and the further following word happens to be aa (and [second next]=aa), and finally the once more further word happens to be a noun (and [third next]=noun), then produce or identify an association (Then CIRN). Accordingly, applying said group of conditions or CIRN to each of the eeggi corpuses produces two outcomes such as the Unsuccessful Outcome 2052 (FIG. 2B) and the Successful Outcome 2058 (FIG. 2B). As illustrated, the unsuccessful Outcome depicts the eeggi of Tom (111) and the eeggi of pilot (444) on a failed association as implied by the Negative Association Symbol 2053 (FIG. 2B). On the other hand, the Successful Outcome depicts the eeggi of Tom (111) and the eeggi of pilot (555) in an association as implied by its Affirmative Association Symbol 2059 (FIG. 2B). Finally, the Results 2060 (FIG. 2) comprises the pilot's noun eeggi (555), the grammatical identifier “noun,” and the meaning of pilot or the person qualified to fly.

FIG. 2C is an exemplary non-limiting block diagram of the inventive method exemplifying a sentence such as “Tom is a pilot” and another identifying language such as grammatical eeggi. Noteworthy, grammatical eeggis identified the word and the grammatical essence of the word in combination with the eeggi's value. For example, if a word is a noun, then its eeggi will use information identifying a noun such as NOUN888 per say. In similar fashion if a word is an adjective, then its eeggi will implement a character(s) only used by adjectives such as ADJEC9999 per se. Returning to FIG. 2C. The Data Corpus 2010 (FIG. 2C) involves the word elements “Tom is a pilot.” Then, the Grammatical eeggi Lexicon 2015 (FIG. 2C) provides information such as the eeggi and the meaning of every word/eeggi of the Data Corpus. However, in such a Lexicon it can also be appreciated that the word “pilot” has two meanings or grammatical eeggis such as: 1) pilot=VERB4 (implying the verb form) which identifies the action of driving or steering, and 2) pilot=NOUN5 (implying the noun form) which identifies a person qualify to fly. Consequentially, when the Data Corpus is converted to the target language (eeggi) two different sentences are formed each comprising a particular or different grammatical eeggi of the word pilot, such as the First Grammatical Eeggi Corpus 2032 (FIG. 2C) involving VERB4 (pilot's verb form) and the other or Second Grammatical Eeggi Corpus 2038 (FIG. 2C) involving NOUN5 (pilot's noun form). Then each grammatical eeggi corpus (First Grammatical Eeggi Corpus and Second Grammatical Eeggi Corpus) is compared or analyzed with a Conceptual-Grammatical Relational Protocol 2040 (FIG. 2C) such a CIRN. As depicted, the Conceptual-Grammatical Protocol makes use of a series of conditional rules to identify or produce an association. For example, the depicted CIRN mentions that if a select grammatical eeggi has the character “NOUN” (If [selected=$ NOUN), and the following grammatical eeggi (to the right as in English) happens to be ii (and [first next]=ii), and the further following grammatical eeggi happens to be aa (and [second next]=aa), and finally the once more further grammatical eeggi happens to have the characters “NOUN” (and [third next]=$NOUN), then produce or identify an association (Then CIRN). Accordingly, applying said group of conditions or CIRN to each of the grammatical eeggi corpuses produces two outcomes such as the Unsuccessful Grammatical Eeggi Outcome 2052 (FIG. 2C) and the Successful Grammatical Eeggi Outcome 2058 (FIG. 2C). As illustrated, the Unsuccessful Eeggi Outcome depicts the grammatical eeggi of Tom (NOUN2) and the grammatical eeggi of pilot (VERB4) on a failed association as implied by the Negative Association Symbol 2053 (FIG. 2C). On the other hand, the Successful Eeggi Outcome depicts the grammatical eeggi of Tom (NOUN2) and the grammatical eeggi of pilot (NOUN5) in an association as implied by its Affirmative Association Symbol 2059 (FIG. 2C). Finally, the Results 2060 (FIG. 2) comprises the pilot's grammatical eeggi (NOUN5) and the meaning of pilot or the person qualified to fly.

Noteworthy, there are several types of eeggis, types of CIRN, types of specialized CIRN, forms to associate information, types of lexicons and their corresponding combinations, each capable of generating a figure depicting the steps of the inventing method. Accordingly, to avoid illustrating possibly hundreds of figures and to simplify the present disclosure, additional figures and examples are evaded thus leading the reader to visualize said additional combinations without ever departing from the main scope and spirit of the disclosed inventive method.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method and system for disambiguating a meaning from a word capable of identifying several meanings (homonyms) can be appreciated. The described method overcomes many of the limitations encountered by current information technologies such as word processors, search engines, translation software, and others when dealing with homonyms which fail to make use of identifying or selecting a single meaning from a plurality of meanings, thus permitting or generating irrelevance, and user confusion.

1. A method for disambiguating information comprising the steps of:
a) Identifying a Data corpus comprising a plurality of words,
b) Identifying a word in said Data Corpus having a plurality of Grammatical Identifications,
c) Selecting one Grammatical Identification from said plurality of Grammatical Identifications of said word,
d) Performing an analysis, such as CIRN, of said Data Corpus implementing said word and said selected Grammatical Identification,
e) Identifying an outcome of said analysis; wherein said outcome involves at least one of a: association of said word and identification of an association of said word,
f) Identifying a meaning of said word implementing at least one of a: said outcome, said analysis, said selected Grammatical Identification, said association and said identification of an association.
